(19) United States
(12) Patent Application Publication
(10) Pub. No.: US 2010/0138684 A1
(43) Pub. Date: Jun. 3, 2010

(54) MEMORY SYSTEM WITH DYNAMIC SUPPLY VOLTAGE SCALING

(75) Inventors: Kyu-hyoun Kim, Mount Kisco, NY (US); Paul W. Coteus, Yorktown Heights, NY (US); Alan Gara, Mount Kisco, NY (US); Vipin Patel, Wappingers Falls, NY (US); Kenneth L. Wright, Austin, TX (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/326,126

(22) Filed: Dec. 2, 2008

(51) Int. Cl. G06F 1/04; G06F 1/08

(52) U.S. Cl. 713/601; 713/600

(57) ABSTRACT

A memory controller, memory device, and method for dynamic supply voltage scaling in a memory system are provided. The method includes receiving a request for a supply voltage change at the memory controller in the memory system, the supply voltage powering the memory device. The method further includes waiting for any current access of the memory device to complete, and disabling a clock between the memory controller and the memory device. The method also includes changing the supply voltage responsive to the request, and enabling the clock.

### BACKGROUND

This invention relates generally to computer memory systems, and more particularly to memory systems and devices with dynamic supply voltage scaling.

Contemporary high performance computing main memory systems are generally composed of one or more dynamic random access memory (DRAM) devices, which are connected to one or more processors via one or more memory control elements. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, on an ongoing basis, to create improved and/or innovative solutions to maximizing overall system performance and density by improving the memory system/subsystem design and/or structure. High-availability systems present further challenges as related to overall system reliability due to customer expectations that new computer systems will markedly surpass existing systems in regard to mean-time-between-failure (MTBF), in addition to offering additional functions, increased performance, reduced latency, increased storage, lower operating costs, etc. Other frequent customer requirements further exacerbate the memory system design challenges, and include such items as ease of upgrade and reduced system environmental impact (such as space, power and cooling).

### SUMMARY

An exemplary embodiment is a memory device including a memory core. The memory core is responsive to a variable external supply voltage configurable by a memory controller between a lower power mode of operation and a higher power mode of operation.

Another exemplary embodiment is a memory controller. The memory controller includes memory control logic to interface with a processor. The memory controller also includes a memory input/output interface to interface with a memory device. The memory controller further includes supply voltage control logic to decrease supply voltage delivered from a power supply to the memory device in response to a request for a lower power mode of operation, and increasing the supply voltage delivered from the power supply to the memory device in response to a request for a higher power mode of operation.

A further exemplary embodiment is a method for dynamic supply voltage scaling in a memory system. The method includes receiving a request for a supply voltage change at a memory controller in the memory system, the supply voltage powering a memory device. The method further includes waiting for any current access of the memory device to complete, and disabling a clock between the memory controller and the memory device. The method also includes changing the supply voltage responsive to the request, and enabling the clock.

An additional exemplary embodiment is a design structure tangibly embodied in a machine-readable medium for designing, manufacturing, or testing an integrated circuit. The design structure includes memory control logic to interface with a processor, and a memory input/output interface to interface with a memory device. The design structure further includes supply voltage control logic to decrease supply voltage delivered from a power supply to the memory device in response to a request for a lower power mode of operation, and increasing the supply voltage delivered from the power supply to the memory device in response to a request for a higher power mode of operation.

Other systems, methods, apparatuses, and/or design structures according to embodiments will be or become apparent to one with skill in the art upon review of the following drawings and detailed description. It is intended that all such additional systems, methods, apparatuses, and/or design structures be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts a memory system with dynamic supply voltage scaling that may be implemented by exemplary embodiments;

FIG. 2 depicts an example of a timing diagram using two scaling steps that may be implemented by exemplary embodiments;

FIG. 3 depicts an example of a timing diagram using multiple scaling steps that may be implemented by exemplary embodiments;

FIG. 4 depicts block diagram of a memory controller that may be implemented by exemplary embodiments;

FIG. 5 depicts an exemplary process for dynamic supply voltage scaling in a memory system that may be implemented by exemplary embodiments;

FIG. 6 depicts an example of memory parameter look-up table that may be implemented by exemplary embodiments;

FIG. 7 depicts another example of a memory system with dynamic supply voltage scaling that may be implemented by exemplary embodiments;

FIG. 8 depicts a further example of a memory system with dynamic supply voltage scaling that may be implemented by exemplary embodiments;

FIG. 9 depicts an additional example of a memory system with dynamic supply voltage scaling that may be implemented by exemplary embodiments;

FIG. 10 depicts another example of a memory system with dynamic supply voltage scaling that may be implemented by exemplary embodiments;

FIG. 11 depicts a further example of a memory system with dynamic supply voltage scaling that may be implemented by exemplary embodiments;

FIG. 12 depicts an additional example of a memory system with dynamic supply voltage scaling that may be implemented by exemplary embodiments;

FIG. 13 depicts another example of a memory system with dynamic supply voltage scaling that may be implemented by exemplary embodiments;

FIG. 14 depicts an example of using serial presence detect to identify support of dynamic supply voltage scaling on a memory module that may be implemented by exemplary embodiments; and

FIG. 15 is a flow diagram of a design process used in semiconductor design, manufacture, and/or test.

### DETAILED DESCRIPTION

The invention as described herein provides dynamic supply voltage scaling in a memory system. Under normal operating conditions, a memory device, such as a synchronous dynamic random access memory (DRAM) device, requires a minimum clock frequency and supply voltage (VDD) to perform read and write accesses. The memory device may be able to maintain minimum operating characteristics at even lower frequencies and VDD values while accesses to the memory device are not being performed. For example, in order to maintain volatile content in capacitive storage cells in a storage array of a DRAM device, refreshing of the capacitive storage cells must be performed due to charge decay. Thus, the clock frequency and supply voltage may not be completely disabled for extended periods of time if the volatile content is to be maintained. However, the minimum clock frequency and supply voltage to maintain the volatile content can be lower than that required for active modification of the volatile content. Furthermore, one or more lower clock frequencies and supply voltages can be used to enable accesses at the expense of slower response time as compared to normal high-speed operation.

In an exemplary embodiment, a memory controller in a memory system determines that one or more memory devices do not need to receive full supply voltage and clock frequency, and the memory controller initiates adjustments of the supply voltage and clock frequency accordingly. For example, the memory controller may determine that no requests to read or write data have been received for a predetermined period of time. Alternately, the memory controller can receive a specific command requesting adjustment of a memory parameter that affects timing, frequency, and/or voltage level. The memory controller can monitor other factors, such as temperature, to determine that the supply voltage and clock frequency should be reduced.

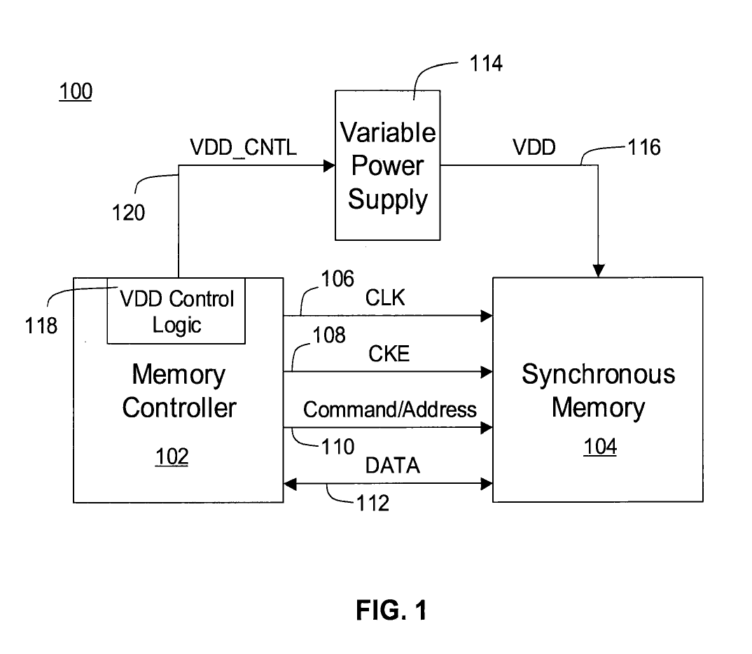

Turning now to FIG. 1, an example of a system 100 is depicted that includes a memory controller 102 in communication with a memory device 104 via multiple bus connections, such as clock (CLK) 106, clock enable (CKE) 108, command/address bus 110, and data bus 112. The memory controller 102 translates memory access commands received from a processor (not depicted) and initiates the requested accesses to the memory device 104. The memory device 104 may be a synchronous DRAM, such as a double-data rate (DDR) DRAM. Various generations of DDR DRAM may have different power requirements for normal operation, for instance, 1.8 Volts for DDR2, 1.5 Volts for DDR3, 1.35 Volts for DDR3+, and 1.2 Volts for DDR4. In an exemplary embodiment, the memory controller 102 commands a variable power supply 114 to dynamically adjust supply voltage (VDD) 116 to the memory device 104. VDD control logic 118 of the memory controller 102 can drive a VDD control command (VDD_CNTL) 120 to the variable power supply 114 to modify the supply voltage level VDD 116 provided to the memory device 104. A reduced voltage level on VDD 116 can also be coupled with a reduced clock frequency on CLK 106, as a low power mode of operation.

Multiple modes of operation with different voltage levels for VDD 116 and frequencies for CLK 106 can be supported. For example, the memory controller 102 may support embodiments where the memory device 104 is DDR3 DRAM or DDR4 DRAM through configurable memory parameters. For each type of memory, multiple low power/low frequency modes can also be supported. For instance, if the memory device 104 is DDR3 DRAM, the memory controller 102 may shift CLK 106 from 800 MHz to 400 MHz and VDD 116 from 1.5 Volts to 1.2 Volts. However, if the memory device 104 is DDR4 DRAM, the memory controller 102 may shift CLK 106 from 800 MHz to 400 MHz and VDD 116 from 1.2 Volts to 0.8 Volts. Additional/lower levels of VDD 116 can be configured to operate in even slower and lower powered configurations. Furthermore, the memory controller 102 may be configured to handle only one memory type (e.g., DDR4 DRAM) with two or more modes of operations.

The system 100 can be configured in variety of architectures, e.g., planar or integrated on horizontal and/or vertical memory modules, with or without flexible links. Although only a single memory device 104 is depicted in communication with the memory controller 102, it will be understood that the memory controller 102 can communicate with multiple memory devices, which may be grouped as modules and/or ranks. The various buses, such as clock 106, clock enable 108, command/address bus 110, and data bus 112, as well as VDD_CTRL 120 can be implemented using electrical and/or optical connections, and can further be implemented using differential or single-ended signaling. Moreover, one or more continuity modules can be inserted between the memory controller 102, the memory device 104, and/or the variable power supply 114 to extend physical separation between them.

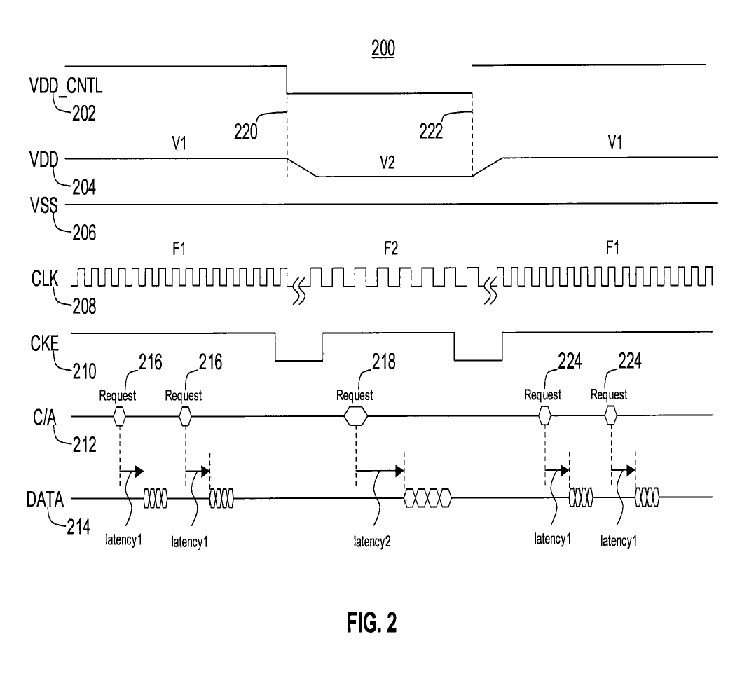

FIG. 2 depicts an example of a timing diagram 200 using two scaling steps for adjusting supply voltage and clock frequency. Timing signals depicted in FIG. 2 include: VDD_CNTL 202, VDD 204, VSS 206, CLK 208, CKE 210, C/A 212, and DATA 214, which are time varying representations as an embodiment that may be mapped to elements of FIG. 1. For example, VDD_CNTL 202 may be a time varying signal transferred on VDD_CTRL 120 of FIG. 1. Similar mappings may exist between VDD 204 and VDD 116, CLK 208 and CLK 106, CKE 210 and CKE 108, C/A 212 and command and address bus 110, as well as DATA 214 and data bus 112. VSS 206 represents a steady state voltage (ground).

While operating in a normal (high-speed) mode, VDD 204 is output at a higher voltage (V1) and CLK 208 oscillates at a higher frequency (F1). In this mode of operation, requests 216 on C/A 212 can be followed by data on DATA 214 after a relatively low latency (latency1), which may be equivalent to about 2 cycles of CLK 208. When the operating mode changes from normal mode to a slow mode, CKE 210 may initially transition to disable use of CLK 208 while the frequency of CLK 208 changes. At voltage supply transition 220, VDD_CNTL 202 changes state, which results in ramping down VDD 204 from higher voltage V1 to a lower voltage (V2). CLK 208 is also reduced in frequency from F1 to F2. Once CLK 208 and VDD 204 have become stable after their respective transitions, CKE 210 can transition to re-enable use of CLK 208. A request 218 on C/A 212 in the slow mode of operation may result a relatively longer latency (latency2) followed by data on DATA 214, as compared to latency1, since each cycle of CLK 208 has a longer period. When the operating mode reverts from slow mode back to normal mode, CKE 210 may initially transition to disable use of CLK 208 while the frequency of CLK 208 changes. At voltage supply transition 222, VDD_CNTL 202 changes state, which results in ramping up VDD 204 from lower voltage V2 back to higher voltage V1. CLK 208 is also increased in frequency from F2 back to F1. Once CLK 208 and VDD 204 have become stable after their respective transitions, CKE 210 can transition to re-enable use of CLK 208. Further requests 224 on C/A 212 can be followed by data on DATA 214 after the relatively low latency (latency1).

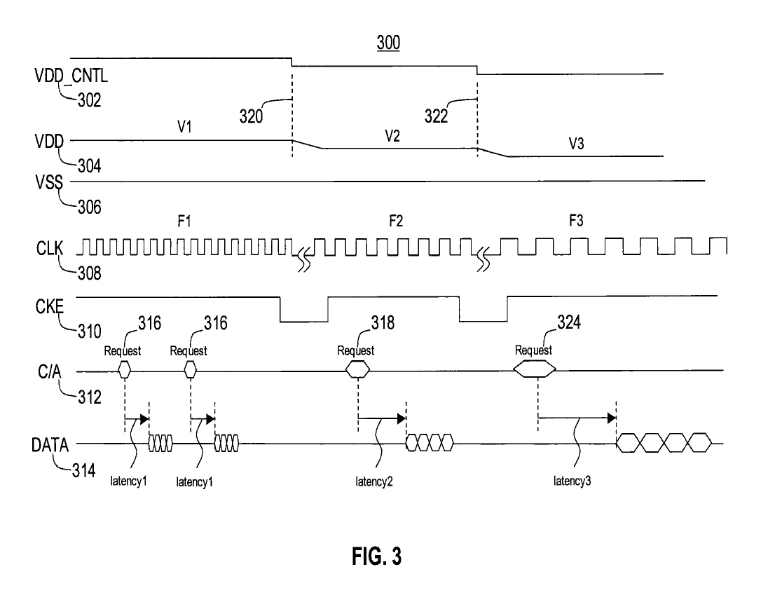

FIG. 3 depicts an example of a timing diagram 300 using multiple scaling steps for adjusting supply voltage and clock frequency. Similar to FIG. 2, timing signals depicted in FIG. 3 include: VDD_CNTL 302, VDD 304, VSS 306, CLK 308, CKE 310, C/A 312, and DATA 314, which are time varying representations as an embodiment that may be mapped to elements of FIG. 1. For example, VDD_CNTL 302 may be a time varying signal transferred on VDD_CTRL 120 of FIG. 1. Similar mappings may exist between VDD 304 and VDD 116, CLK 308 and CLK 106, CKE 310 and CKE 108, C/A 312 and command and address bus 110, as well as DATA 314 and data bus 112. VSS 306 represents a steady state voltage (ground). While FIG. 2 depicts an example supporting two scaling steps, FIG. 3 depicts 3 scaling steps. It will be understood that the example of FIG. 3 can be extended to cover even more steps. For instance, assigning 2 bits for VDD_CNTL 302 can yield up to 4 steps, while assigning 3 bits to VDD_CNTL 302 can result in 8 discrete steps.

While operating in a normal (high-speed) mode, VDD 304 is output at a higher voltage (V1) and CLK 308 oscillates at a higher frequency (F1). In this mode of operation, requests 316 on C/A 312 can be followed by data on DATA 314 after a relatively low latency (latency1), which may be equivalent to about 2 cycles of CLK 308. When the operating mode changes from normal mode to a slower mode, CKE 310 may initially transition to disable use of CLK 308 while the frequency of CLK 308 changes. At voltage supply transition 320, VDD_CNTL 302 changes state, which results in ramping down VDD 304 from higher voltage V1 to a lower voltage (V2). CLK 308 is also reduced in frequency from F1 to F2. Once CLK 308 and VDD 304 have become stable after their respective transitions, CKE 310 can transition to re-enable use of CLK 308. A request 318 on C/A 312 in the slower mode of operation may result a longer latency (latency2) followed by data on DATA 314, as compared to latency1, since each cycle of CLK 308 has a longer period. The operating mode can change to an even slower mode of operation. Again, CKE 310 may transition to disable use of CLK 308 while the frequency of CLK 308 changes. At voltage supply transition 322, VDD_CNTL 302 changes state, which results in a further ramping down of VDD 304 from V2 to a lower voltage V3. CLK 308 is also decreased in frequency from F2 to F3. Once CLK 308 and VDD 304 have become stable after their respective transitions, CKE 310 can transition to re-enable use of CLK 308. Further requests 324 on C/A 312 can be followed by data on DATA 314 after an even greater latency (latency3).

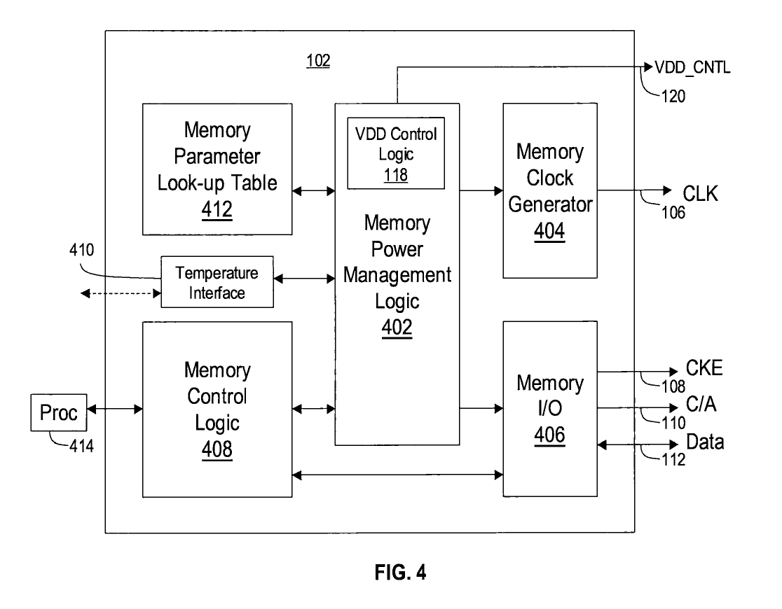

FIG. 4 depicts an embodiment of the memory controller 102 of FIG. 1 in greater detail. In an exemplary embodiment, memory power management logic 402 includes VDD control logic 118 and also interfaces with a memory clock generator 404, a memory I/O interface 406, memory control logic 408, a temperature interface 410, and a memory parameter look-up table 412. The memory power management logic 402 may receive a command to change operating mode from a processor 414 that interfaces via memory control logic 408. The processor 414 may be a microprocessor, multi-core/multi-module processor, a digital signal processor, or any processor architecture known in the art. Alternatively, the memory power management logic 402 can initiate a supply voltage and frequency change based on monitoring the temperature interface 410. For example, the memory power management logic 402 may periodically read a temperature value from the temperature interface 410 and compare it to one or more configurable thresholds (e.g., a hysteresis band) to determine whether the temperature is too high, triggering a reduction in supply voltage and frequency or sufficiently low to support increasing the supply voltage and frequency. The temperature interface 410 may include a temperature sensor (e.g., a resistance temperature detector) or connect to a temperature sensor that is external to the memory controller 102 (e.g., in close proximity to the memory device 104 of FIG. 104).

The memory power management logic 402 may access the memory parameter look-up table 412 to determine various timing and voltage parameters for each mode of operation supported. The timing parameters are used to control timing of transitions and signaling of memory I/O interface 406 for the clock enable 108, command/address bus 110, and data bus 112. The memory I/O interface 406 may include buffers such as one or more first-in first-out (FIFO) buffers, as well as sequencing logic to control transitions of the clock enable 108 and spacing between commands, address values, and data on the command/address bus 110 and data bus 112. The timing parameters from the memory parameter look-up table 412 are also used to establish the clock frequency in the memory clock generator 404 to output as CLK 106. For example, the memory clock generator 404 can include one or more phase-locked loop (PLL), delay locked loop (DLL), and/or a frequency synthesizer to modify the clock frequency on CLK 106. VDD control logic 118 can also use one or more values from the memory parameter look-up table 412 to drive supply voltage commands on VDD_CNTL 120.

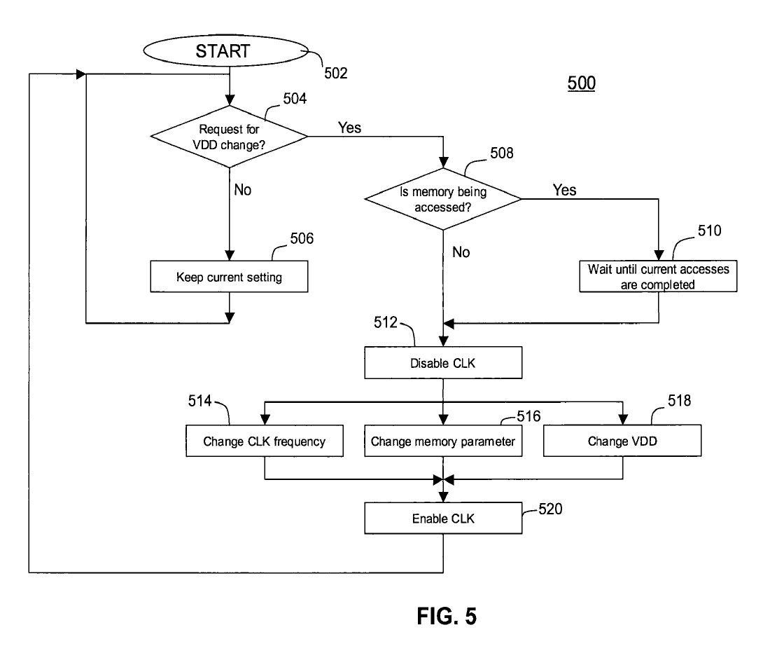

FIG. 5 depicts an example of a process 500 for dynamic supply voltage scaling in a memory system, such as the system 100 of FIG. 1. The memory controller 102 of FIGS. 1 and 4 may perform the process 500. Additionally, the process 500 can be applied to the system 100, as well as the memory system described in further detail herein, such as memory systems 700, 800, 900, 1000, 1100, 1200, and 1300. At block 502, the process 500 begins. At block 504, memory power management logic 402 of FIG. 4 determines whether a request for supply voltage change is detected. The request may be initiated externally, e.g., from processor 414, or internally, e.g., based on temperature readings acquired from temperature interface 410. If no change request is detected, then the current settings are maintained at block 506 and the memory power management logic 402 continues monitoring for a change request. Otherwise, if a change request is detected, the memory controller 102 determines whether memory is currently being accessed at block 508. The determination may be based on whether a command has been received at the memory control logic 408 that has not completed. The memory I/O interface 406 can also be used in the determination, e.g., based on sequencing and buffer content of commands and responses. If memory is currently being accessed, then the memory power management logic 402 waits until current accesses are completed at block 510.

At block 512, the memory power management logic 402 disables CLK 106. Disabling may be performed directly by commanding the memory clock generator 404 to disable the CLK 106, or indirectly by commanding the memory I/O interface 406 to disable CKE 108. Disabling CLK 106 (directly or indirectly) may avoid error conditions that may occur while making timing, frequency, and voltage adjustments. At block 514, the memory power management logic 402 changes the frequency output on CLK 106 via commanding the memory clock generator 404. The memory power management logic 402 can determine a specific frequency for the command based on a value received at the memory control logic 408 or through performing a mode specific look up operation in the memory parameter look-up table 412. At block 516, the memory power management logic 402 may change one or more memory parameters, such as a timing characteristic at the memory I/O interface 406 to drive the clock enable 108, command/address bus 110, and data bus 112. At block 518, the VDD control logic 118 of the memory power management logic 402 may command a VDD change, outputting VDD_CNTL 120 and/or other signals to change supply voltage at one or more memory devices. At block 520, the memory power management logic 402 can re-enable the CLK 106, which may be performed by changing the state of CKE 108.

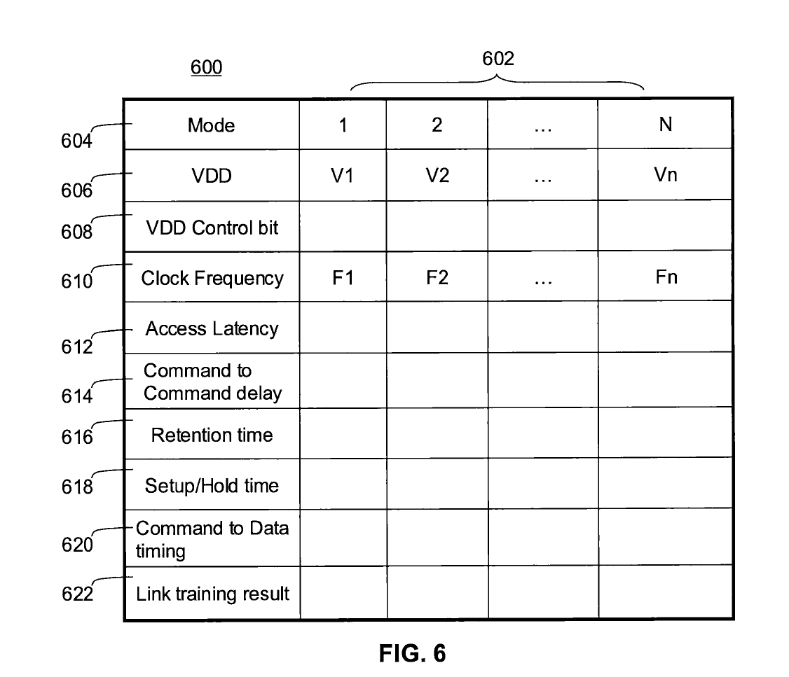

FIG. 6 depicts an example of a memory parameter look-up table 600 that may be implemented in an exemplary embodiment. For example the memory parameter look-up table 600 can represent an embodiment of the memory parameter look-up table 412 of FIG. 4. In an exemplary embodiment, the memory parameter look-up table 600 includes multiple columns 602 that represent parameters associated with different modes of operation 604. Example parameters may include a VDD parameter 606, a VDD control bit 608, clock frequency 610, access latency 612, command-to-command delay 614, retention time 616, setup/hold time 618, command-to-data timing 620, and link training result 622. As different modes of operation 604 are requested, corresponding parameters are read from the memory parameter look-up table 600 and used to adjust voltage, timing, and frequency for a memory controller, such as memory controller 102 of FIGS. 1 and 4. For example, if operating mode 604 is set to “1”, then the VDD parameter 606 maps to V1 and clock frequency 610 maps to F1. If operating mode 604 is set to “2”, then the VDD parameter 606 maps to V2 and clock frequency 610 maps to F2. Two or more columns 602 can be supported in the memory parameter look-up table 600 (e.g., up to “N”) to enable 2 or more modes of operation.

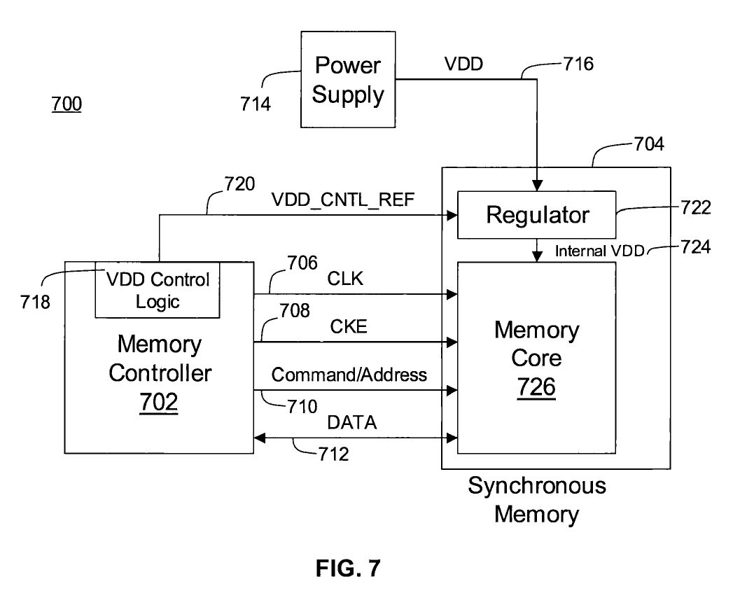

FIG. 7 depicts another example of a memory system 700 with dynamic supply voltage scaling. Similar to the system 100, the memory system 700 includes a memory controller 702 in communication with a memory device 704 via multiple bus connections, such as clock (CLK) 706, clock enable (CKE) 708, command/address bus 710, and data bus 712. However, in this example power supply 714 outputs supply voltage (VDD) 716 to the memory device 704 independent of commands issued from VDD control logic 718 of the memory controller 702. Instead, the VDD control logic 718 outputs a VDD control reference (VDD_CNTL_REF) 720 to a voltage regulator 722 in the memory device 704. In response to the VDD_CNTL_REF 720, the voltage regulator 722 adjusts the voltage level of VDD 716 to produce an internal VDD 724. The internal VDD 724 provides memory core 726 of the memory device 704 with a supply voltage for operation. The memory core 726 may include a memory cell array of storage cells, such as dynamic capacitive storage cells, as well as periphery control circuitry to access specific locations and refresh charge in the memory core 726. As described in reference to FIG. 1, it will be understood that the memory system 700 may include multiple memory devices 704.

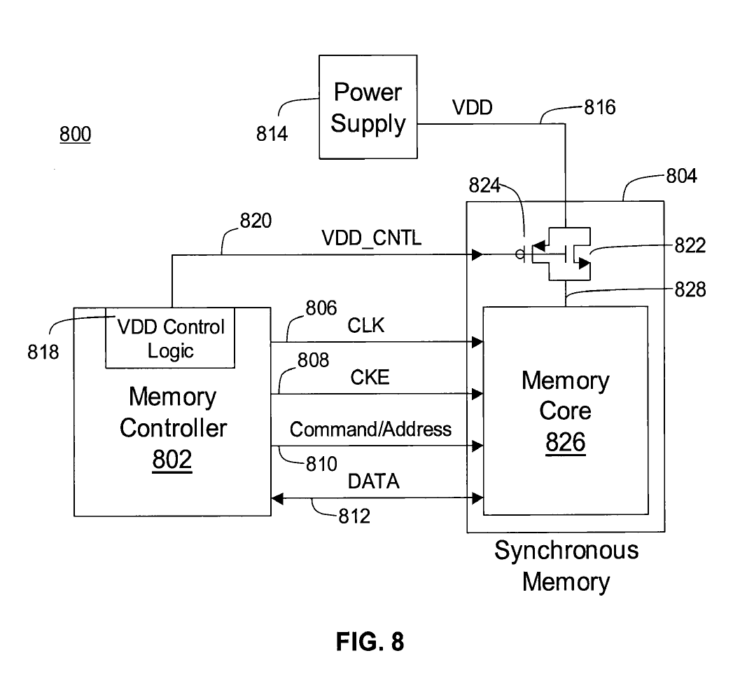

FIG. 8 depicts a further example of a memory system 800 with dynamic supply voltage scaling. Similar to the memory system 700 of FIG. 7, the memory system 800 includes a memory controller 802 in communication with a memory device 804 via multiple bus connections, such as clock (CLK) 806, clock enable (CKE) 808, command/address bus 810, and data bus 812. Power supply 814 outputs supply voltage (VDD) 816 to the memory device 804 independent of commands issued from VDD control logic 818 of the memory controller 802. Instead, the VDD control logic 818 outputs a VDD control (VDD_CNTL) 820 to metal-oxide-semiconductor field-effect transistor (MOSFET) based switching logic in the memory device 804, including NFET 822 and PFET 824. In response to the VDD_CNTL 820 activating PFET 824, the voltage level of VDD 816 may be output to memory core 826 via connection 830. In response to the VDD_CNTL 820 activating NFET 822, the voltage level of VDD 816 less an offset value may be output to the memory core 826 via connection 830. The memory core 826 can include a memory cell array of storage cells, such as dynamic capacitive storage cells, as well as periphery control circuitry to access specific locations and refresh charge in the memory core 826. As described in reference to FIG. 1, it will be understood that the memory system 800 may include multiple memory devices 804. Moreover, additional pairings of the NFET 822 and PFET 824 can be included with different offset values to create multiple voltage levels.

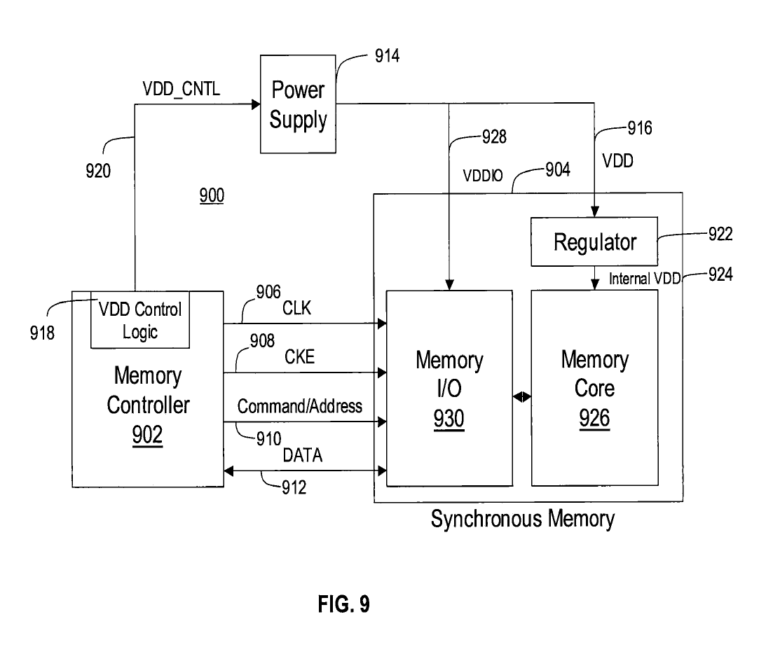

FIG. 9 depicts an additional example of a memory system 900 with dynamic supply voltage scaling. Similar to the system 100, the memory system 900 includes a memory controller 902 in communication with a memory device 904 via multiple bus connections, such as clock (CLK) 906, clock enable (CKE) 908, command/address bus 910, and data bus 912. In this example, power supply 914 outputs supply voltage (VDD) 916 to the memory device 904 in response to commands issued from VDD control logic 918 of the memory controller 902. The VDD control logic 918 outputs a VDD control command (VDD_CNTL) 920 to the power supply 914. The power supply 914 outputs both VDD 916 and VDD I/O voltage (VDDIO) 928. A voltage regulator 922 in the memory device 904 further conditions VDD 916 to produce an internal VDD 924. The internal VDD 924 provides memory core 926 of the memory device 904 with a supply voltage for operation. The memory core 926 may include a memory cell array of storage cells, such as dynamic capacitive storage cells, as well as periphery control circuitry to access specific locations and refresh charge in the memory core 926. The memory device 904 also includes memory I/O interface 930 that interfaces with the memory core 926 and various bus signals such as CLK 906, CKE 908, command/address bus 910, and data bus 912 from the memory controller 902. Thus, multiple configurable voltage domains can exist within the memory device 904. In an exemplary embodiment, the VDDIO 928 voltage level remains fixed, but the internal VDD 924 voltage level is adjusted as the memory controller 902 modifies frequency and/or timing parameters. As described in reference to FIG. 1, it will be understood that the memory system 900 may include multiple memory devices 904.

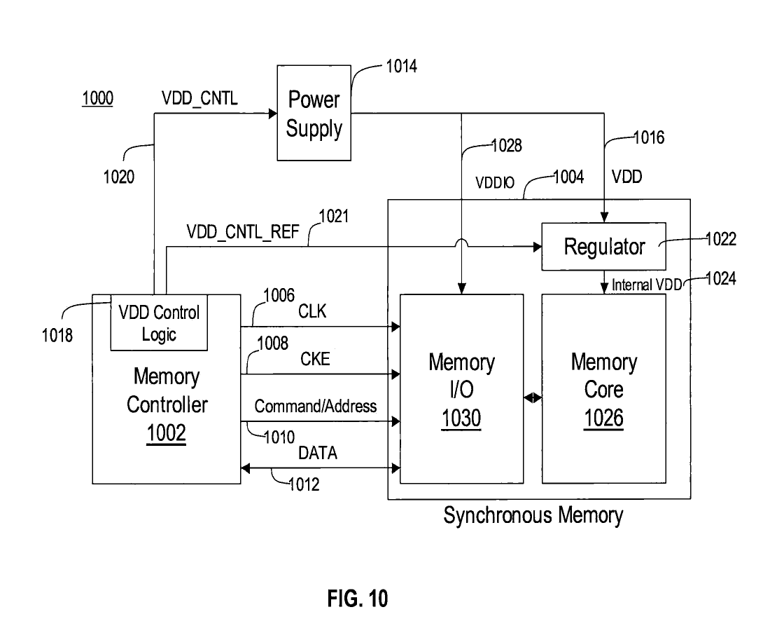

FIG. 10 depicts another example of a memory system 1000 with dynamic supply voltage scaling. Similar to the memory system 900 of FIG. 9, the memory system 1000 includes a memory controller 1002 in communication with a memory device 1004 via multiple bus connections, such as clock (CLK) 1006, clock enable (CKE) 1008, command/address bus 1010, and data bus 1012. Power supply 1014, VDD 1016, VDD control logic 1018, VDD_CNTL 1020, regulator 1022, internal VDD 1024, memory core 1026, VDDIO 1028, and memory I/O interface 1030 include similar functionality and features as described in reference to the corresponding elements of FIG. 9. However, the memory system 1000 of FIG. 10 includes an additional to directly control the regulator 1022 from the VDD control logic 1018 via VDD control reference (VDD_CNTL_REF) 1021. This provides increased flexibility in setting the voltage level of the internal VDD 1024, which can increase the number of operating modes supported. Also as described in reference to FIG. 9, it will be understood that the memory system 1000 may include multiple memory devices 1004. When multiple memory devices 1004 are implemented, the memory controller 1002 may use one setting for the VDD_CNTL 1020 to output a common level for VDD 1016 to all of the memory devices 1004, and then further fine-tune the internal VDD 1024 of each memory device 1004 using independent implementations of the VDD_CNTL_REF 1021.

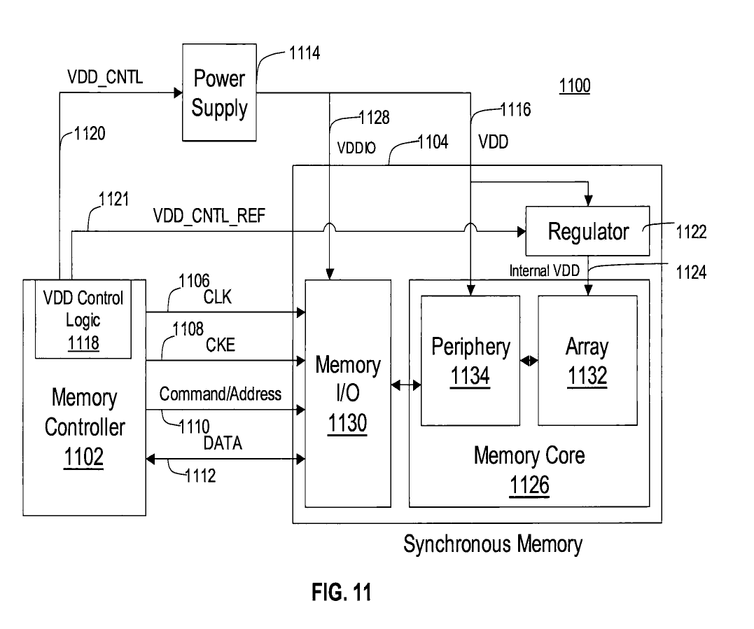

FIG. 11 depicts a further example of a memory system 1100 with dynamic supply voltage scaling. Similar to the memory system 1000 of FIG. 10, the memory system 1100 includes a memory controller 1102 in communication with a memory device 1104 via multiple bus connections, such as clock (CLK) 1106, clock enable (CKE) 1108, command/address bus 1110, and data bus 1112. Power supply 1114, VDD 1116, VDD control logic 1118, VDD_CNTL 1120, VDD_CNTL_REF 1121, regulator 1122, internal VDD 1124, memory core 1126, VDDIO 1128, and memory I/O interface 1130 include similar functionality and features as described in reference to the corresponding elements of FIG. 10. However, the memory system 1100 of FIG. 11 provides any even greater degree of control in voltage level adjustment within the memory core 1126. In an exemplary embodiment, the internal VDD 1124 provides regulated power to array 1132, while periphery circuitry 1134 is powered by VDD 1116. The array 1132 may include row and column storage cells (e.g., capacitor-based storage). The periphery circuitry 1134 can include support circuitry, such as access logic, sense amplifiers, and logic to refresh the charge in the cells of the array 1132. The periphery circuitry 1134 can enable row and column selection strobes to access the array 1132 based on addresses and commands received at the memory I/O interface 1130. This embodiment can apply a low voltage to the array 1132 when state changes are not occurring to the values stored in the array 1132, while maintaining a higher voltage to refresh the charge in the storage cells for retaining their existing values.

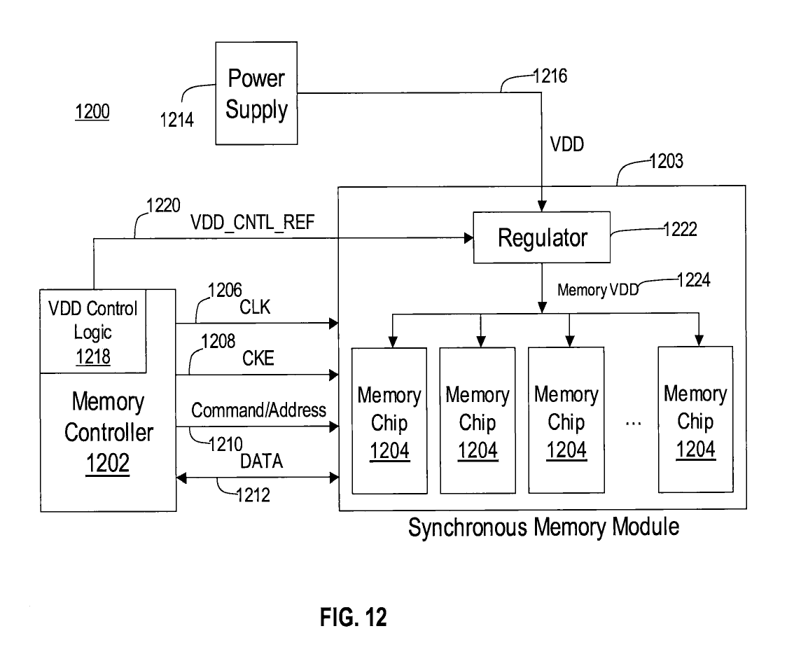

FIG. 12 depicts an example of a memory system 1200 with dynamic supply voltage scaling. Similar to the memory system 700 of FIG. 7, the memory system 1200 of FIG. 12 includes a memory controller 1202 with multiple bus connections, such as clock (CLK) 1206, clock enable (CKE) 1208, command/address bus 1210, and data bus 1212. Power supply 1214, VDD 1216, VDD control logic 1218, and VDD_CNTL_REF 1220 provide functionality similar to that previously described. The memory system 1200 also includes a memory module 1203 with multiple memory chips 1204. The memory chips 1204 may be synchronous DRAM devices (e.g., DDR3, DDR4, etc.). Here, regulator 1222 is located on the memory module 1203, rather than internal to the memory chips 1204. The regulator 1222 is controlled by VDD_CNTL_REF 1220 to create a regulated voltage level on memory VDD 1224 to power the memory chips 1224 with an adjustable voltage level.

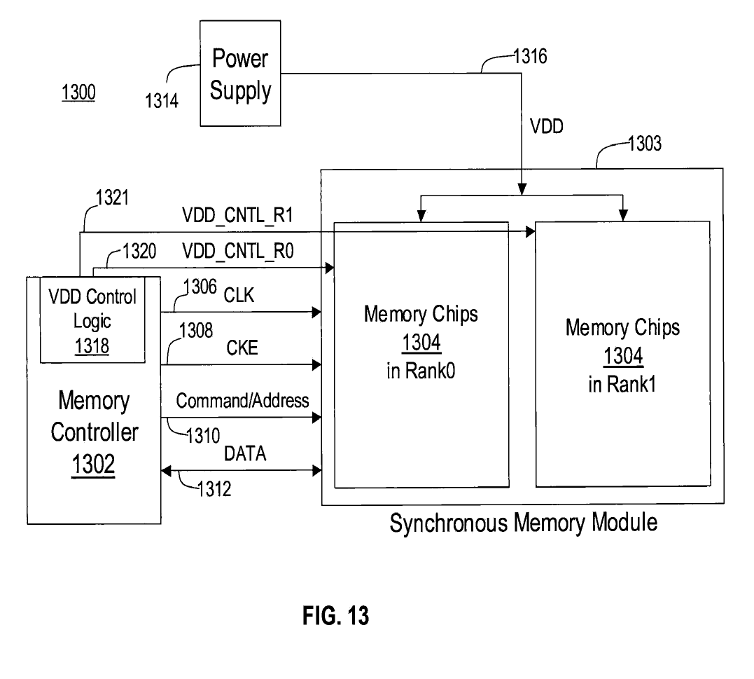

FIG. 13 depicts another example of a memory system 1300 with dynamic supply voltage scaling. Similar to the memory system 1200 of FIG. 12, the memory system 1300 of FIG. 13 includes a memory controller 1302 with multiple bus connections, such as clock (CLK) 1306, clock enable (CKE) 1308, command/address bus 1310, and data bus 1312. Power supply 1314, VDD 1316, and VDD control logic 1318 provide functionality similar to that previously described. The memory system 1300 also includes a memory module 1303 with multiple memory chips 1304. The memory chips 1304 of memory module 1303 can be organized into multiple ranks, such as Rank0 and Rank1. In an exemplary embodiment, each rank (e.g., Rank0 and Rank1) includes independently controllable supply voltages that the VDD control logic 1318 controls. For example, the VDD control logic 1318 can drive VDD control signals VDD_CNTL_R0 1320 and VDD_CNTL_R1 1321 to Rank0 and Rank1 respectively. The control signals VDD_CNTL_R0 1320 and VDD_CNTL_R1 1321 can modify supply voltage delivered to the memory chips 1304 in each rank, using for instance, a regulator or MOSFET switching.

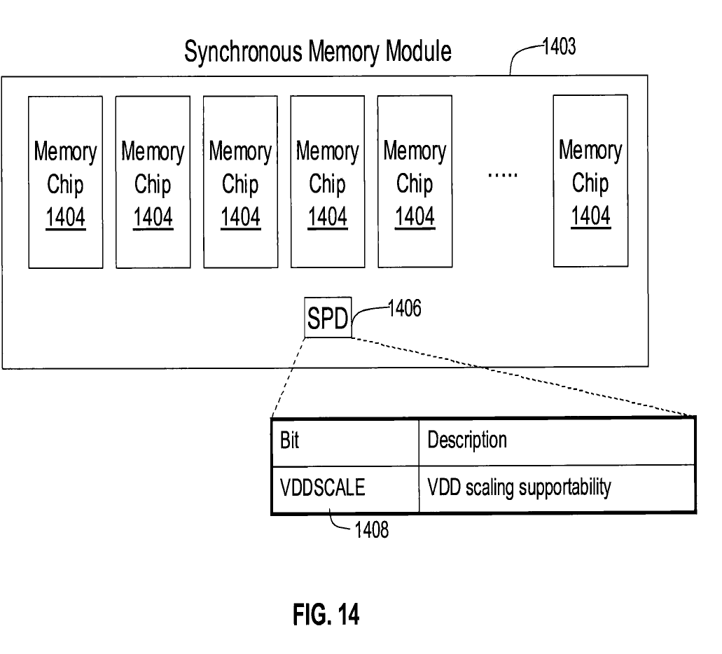

FIG. 14 depicts an example of using serial presence detect (SPD) 1406 to identify support of dynamic supply voltage scaling on a memory module 1403. Memory chips 1404 on memory module 1403 may be synchronous DRAM (e.g., DDR3, DDR4, DDRx). The SPD 1406 may be an EEPROM device that contains parameter data associated with the memory module 1403. The SPD 1406 can contain timing parameters, manufacturer, serial number and other useful information about the memory module 1403. One or more bits in the SPD 1406 may be dedicated to supply voltage scaling capabilities of the memory module 1403. For example, the SPD 1406 may include VDDSCALE 1408 indicating whether the memory module 1403 supports configurable/scalable supply voltage. Other bits (not depicted) can further define the specific configurations supported, such as variable external supply, variable internal supply, and variable on module supply, among other options.

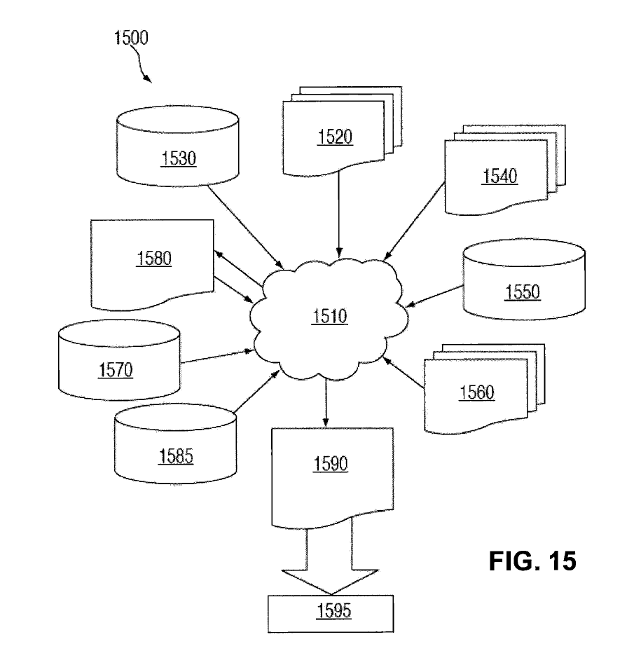

FIG. 15 shows a block diagram of an exemplary design flow 1500 used for example, in semiconductor IC logic design, simulation, test, layout, and manufacture. Design flow 1500 includes processes and mechanisms for processing design structures or devices to generate logically or otherwise functionally equivalent representations of the design structures and/or devices described above and shown in FIGS. 1-14. The design structures processed and/or generated by design flow 1500 may be encoded on machine readable transmission or storage media to include data and/or instructions that when executed or otherwise processed on a data processing system generate a logically, structurally, mechanically, or otherwise functionally equivalent representation of hardware components, circuits, devices, or systems. Design flow 1500 may vary depending on the type of representation being designed. For example, a design flow 1500 for building an application specific IC (ASIC) may differ from a design flow 1500 for designing a standard component or from a design flow 1500 for instantiating the design into a programmable array, for example a programmable gate array (PGA) or a field programmable gate array (FPGA) offered by Altera® Inc. or Xilinx® Inc.

FIG. 15 illustrates multiple such design structures including an input design structure 1520 that is preferably processed by a design process 1510. Design structure 1520 may be a logical simulation design structure generated and processed by design process 1510 to produce a logically equivalent functional representation of a hardware device. Design structure 1520 may also or alternatively comprise data and/or program instructions that when processed by design process 1510, generate a functional representation of the physical structure of a hardware device. Whether representing functional and/or structural design features, design structure 1520 may be generated using electronic computer-aided design (ECAD) such as implemented by a core developer/designer. When encoded on a machine-readable data transmission, gate array, or storage medium, design structure 1520 may be accessed and processed by one or more hardware and/or software modules within design process 1510 to simulate or otherwise functionally represent an electronic component, circuit, electronic or logic module, apparatus, device, or system such as those shown in FIGS. 1-14. As such, design structure 1520 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 1510 preferably employs and incorporates hardware and/or software modules for synthesizing, translating, or otherwise processing a design/simulation functional equivalent of the components, circuits, devices, or logic structures shown in FIGS. 1-14 to generate a netlist 1580 which may contain design structures such as design structure 1520. Netlist 1580 may comprise, for example, compiled or otherwise processed data structures representing a list of wires, discrete components, logic gates, control circuits, I/O devices, models, etc. that describes the connections to other elements and circuits in an integrated circuit design. Netlist 1580 may be synthesized using an iterative process in which netlist 1580 is resynthesized one or more times depending on design specifications and parameters for the device. As with other design structure types described herein, netlist 1580 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 1510 may include hardware and software modules for processing a variety of input data structure types including netlist 1580. Such data structure types may reside, for example, within library elements 1530 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1540, characterization data 1550, verification data 1560, design rules 1570, and test data files 1585 which may include input test patterns, output test results, and other testing information. Design process 1510 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1510 without deviating from the scope and spirit of the invention. Design process 1510 may also include modules for performing standard circuit design processes such as timing analysis, verification, design rule checking, place and route operations, etc.

Design process 1510 employs and incorporates logic and physical design tools such as HDL compilers and simulation model build tools to process design structure 1520 together with some or all of the depicted supporting data structures along with any additional mechanical design or data (if applicable), to generate a second design structure 1590. Design structure 1590 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 1520, design structure 1590 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-14. In one embodiment, design structure 1590 may comprise a compiled, executable HDL simulation model that functionally simulates the devices shown in FIGS. 1-14.

Design structure 1590 may also employ a data format used for the exchange of layout data of integrated circuits and/or symbolic data format (e.g. information stored in a GDSII (GDS2), GL1, OASIS, map files, or any other suitable format for storing such design data structures). Design structure 1590 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-14. Design structure 1590 may then proceed to a stage 1595 where, for example, design structure 1590: proceeds to tape-out, is released to manufacturing, is released to a mask house, is sent to another design house, is sent back to the customer, etc.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Technical effects include dynamic voltage supply and frequency scaling in a memory system. By monitoring for conditions in which the clock frequency sent to one or more memory devices can be reduced, a memory controller can also determine whether the supply voltage can also be reduced. Reducing the clock frequency and supply voltage result in lower power consumption and heat. The reduction in power and heat may not only reduce expenses associated with operating the memory system, but can also extend the service life of the memory system. The reduced supply voltage may be a minimum to operate a subset of support circuitry in the memory devices and to account for leakage and parasitic losses. Isolating different portions of the memory devices to use varying voltage scaling may further enhance configurability of the memory system and ensure that specific circuitry receives an acceptable supply voltage even while operating in a lower power mode of operation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Moreover, the use of the terms first, second, etc. do not denote any order or importance, but rather the terms first, second, etc. are used to distinguish one element from another.

What is clamed is:

1. A memory device comprising:
a memory core, the memory core responsive to a variable external supply voltage configurable by a memory controller between a lower power mode of operation and a higher power mode of operation.

2. The memory device of claim 1 wherein the memory device receives a clock with a configurable frequency from the memory controller comprising a lower clock frequency in the lower power mode of operation and a higher clock frequency in the higher power mode of operation.

3. The memory device of claim 1 wherein the memory device is a synchronous dynamic random access memory chip.

4. The memory device of claim 1 further comprising a memory input/output interface to interface bus signals from the memory controller to the memory core, wherein voltage supplied to the memory input/output interface is independently regulated with respect to the memory core.

5. The memory device of claim 4 wherein voltage supplied to the memory core is an internally regulated supply voltage derived from the variable external supply voltage.

6. The memory device of claim 5 wherein the memory device includes a regulator controlled by the memory controller, the regulator producing the internally regulated supply voltage.

7. The memory device of claim 6 wherein the memory core further comprises an array of storage cells and periphery circuitry to control access to the array, and further wherein the internally regulated supply voltage is provided to the array and the variable external supply voltage is provided to the periphery circuitry.

8. The memory device of claim 1 wherein the variable external supply voltage is supplied to multiple memory devices on a memory module arranged as one or more ranks with independent control of the variable external supply voltage per rank.

9. A memory controller comprising:
memory control logic to interface with a processor;
a memory input/output interface to interface with a memory device; and
supply voltage control logic to decrease supply voltage delivered from a power supply to the memory device in response to a request for a lower power mode of operation, and increasing the supply voltage delivered from the power supply to the memory device in response to a request for a higher power mode of operation.

10. The memory controller of claim 9 further comprising a memory clock generator to provide a clock to the memory device, wherein the memory clock generator provides a reduced clock frequency to the memory device in the lower power mode of operation and the higher clock frequency to the memory device in the higher power mode of operation.

11. The memory controller of claim 9 further comprising:
a memory parameter look-up table to configure memory parameters in response to the mode of operation, wherein the memory parameters include timing, clock frequency, and level of the supply voltage.

12. The memory controller of claim 11 wherein the memory controller supports additional modes of operation as defined in the memory parameter look-up table.

13. The memory controller of claim 11 further comprising a temperature interface to acquire a temperature, wherein the lower power mode of operation is requested in response the temperature exceeding a threshold, and the higher power mode of operation is requested in response the temperature being below the threshold.

14. The memory controller of claim 9 wherein the power supply adjusts the supply voltage external to the memory device.

15. The memory controller of claim 9 wherein mode of operation requests are generated from one of: the processor and memory power management logic within the memory controller.

16. A method comprising:
receiving a request for a supply voltage change at a memory controller in a memory system, the supply voltage powering a memory device;
waiting for any current access of the memory device to complete;
disabling a clock between the memory controller and the memory device;
changing the supply voltage responsive to the request; and
enabling the clock.

17. The method of claim 16 further comprising:
adjusting a clock frequency of the clock prior to enabling the clock.

18. The method of claim 17 wherein the memory controller includes a memory parameter look-up table, the supply voltage change is associated with an operating mode defined in the memory parameter look-up table, and the memory controller further adjusts a timing parameter for accessing the memory device in response to a timing value in the memory parameter look-up table associated with the operating mode.

19. The method of claim 1, wherein the memory controller accesses a serial presence detect on a memory module to determine whether the memory module supports supply voltage scaling.

20. The method of claim 16 wherein the supply voltage is adjusted external to the memory device in response to a control command from the memory controller.

21. A design structure tangibly embodied in a machine-readable medium for designing, manufacturing, or testing an integrated circuit, the design structure comprising:
memory control logic to interface with a processor;
a memory input/output interface to interface with a memory device; and
supply voltage control logic to decrease supply voltage delivered from a power supply to the memory device in response to a request for a lower power mode of operation, and increasing the supply voltage delivered from the power supply to the memory device in response to a request for a higher power mode of operation.

22. The design structure of claim 21, wherein the design structure comprises a netlist.

23. The design structure of claim 21, wherein the design structure resides on storage medium as a data format used for the exchange of layout data of integrated circuits.

24. The design structure of claim 21, wherein the design structure resides in a programmable gate array.
